(19) United States
(12) Patent Application Publication
(10) Pub. No.: US 2026/0216895 A1
(43) Pub. Date: Jul. 30, 2026

(54) EXTRACTION AND INSERTION IMPLEMENT FOR DEBRIS REMOVAL

(71) Applicant: Chester Zachary Szymczak, Bountiful, UT (US)

(72) Inventor: Chester Zachary Szymczak, Bountiful, UT (US)

(21) Appl. No.: 19/037,227

(22) Filed: Jan. 26, 2025

(51) Int. Cl. B25J 15/06; B25J 1/04; H01F 7/20; H04N 23/50

(52) U.S. Cl. CPC B25J 15/0608; B25J 1/04; H01F 7/206; H04N 23/555

(57) ABSTRACT

An extraction and insertion implement and method of retrieving foreign object debris using a magnetically-activated elongated implement to remove metallic debris. The implement may be used in mechanical and medical applications and may comprise a camera and/or a light in separate cylindrical housings affixed to an elongated rod.

### FIELD OF THE INVENTION

This invention relates to an extraction and insertion implement, and more particularly relates to an implement having magnetic retrieval means operable to form a magnetic attachment with foreign object debris.

### BACKGROUND

### Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Mechanics and lay people must exercise caution when repairing or working on mechanized vehicles such as automobiles that foreign object debris (FOD) is not left behind, including screws, bolts, nuts, washers, shards and the like. Numerous accidents have resulted from FOD as small as a few millimeters from becoming lodged between control surfaces of an airframe, for instance, or in such a manner as to inhibit movement of mechanically articulating components such as power-steering and gears. Additionally, surgeons performing sensitive surgeries must exercise care that metal objects, such as screws, are not left inside a patient's body.

Because efficient means of inserting screws and extracting debris from confined spaces are unknown in the art, screws, bolts, and pins are often left as foreign object debris in machines and construction. Efficient tools used to extract this debris are generally unknown in the art. There exists a need in the art for a method, system and apparatus for curing this deficiency, which deficiency curing is an object of the present invention.

### SUMMARY

From the foregoing discussion, it should be apparent that a need exists for an extraction and insertion implement for debris removal. The present invention has been developed in response to the present state of the art, and in particular, in response to the problems and needs in the art that have not yet been fully solved by currently available tools that can both extract and insert foreign object debris. Accordingly, the present invention has been developed to provide an implement to extract foreign object debris, the implement comprising: a handle comprising a power supply; a rod having a proximal end and a distal end, the rod further being generally rigid and elongated; and a flange joined with the distal end of the rod, the flange member being substantially resilient, the flange comprising a conductive coil or forming a magnetic field.

The rod may have, but is not required to have, a generally cylindrical shape.

A second implement to extract foreign object debris, the implement comprising: a handle comprising a power supply; a rod having a proximal end and a distal end, the rod comprising a polymeric shaft having interior semi-rigid conductors operable to conduct electricity to one or more of the magnet, a camera and a light, wherein the semi-rigid conductors are also operable to impart form applied to the rod; and a flange joined with the distal end of the rod, the flange member being substantially resilient, the flange comprising a conductive coil or forming a magnetic field.

The implement may further comprise an LED light.

In some embodiments, the implement further comprises a camera.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating one embodiment of an extraction implement for retrieving foreign object debris in accordance with the present invention;

FIG. 2 is an environmental, perspective view illustrating one embodiment of an extraction implement for retrieving foreign object debris in accordance with the present invention;

FIG. 3 is a perspective view illustrating one embodiment of an extraction implement for retrieving foreign object debris in accordance with the present invention; and FIG. 4 is a perspective view illustrating one embodiment of a method for extracting debris in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

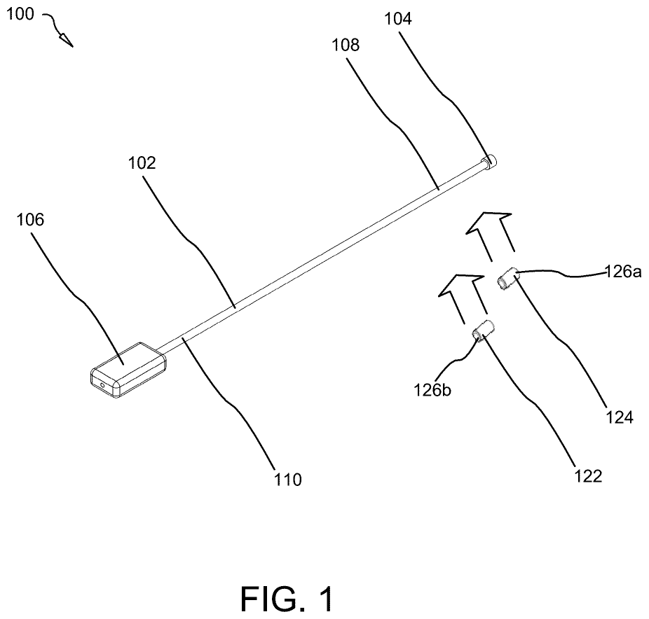

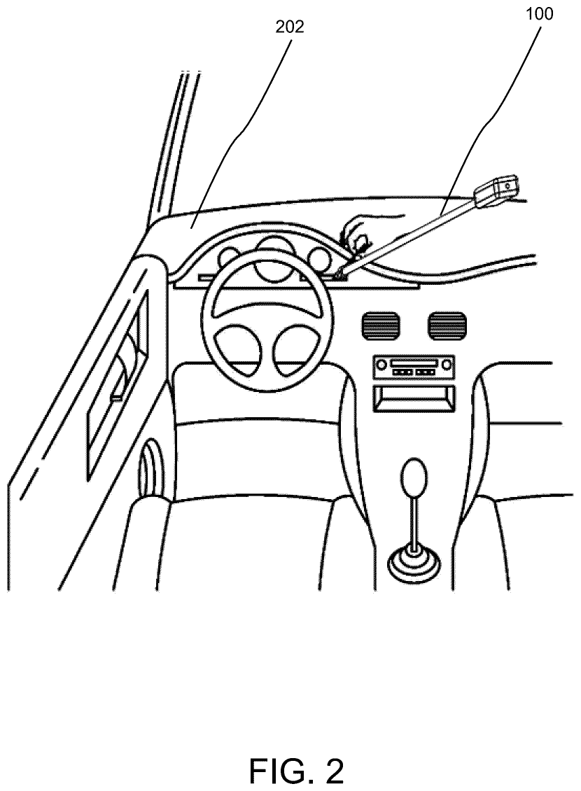

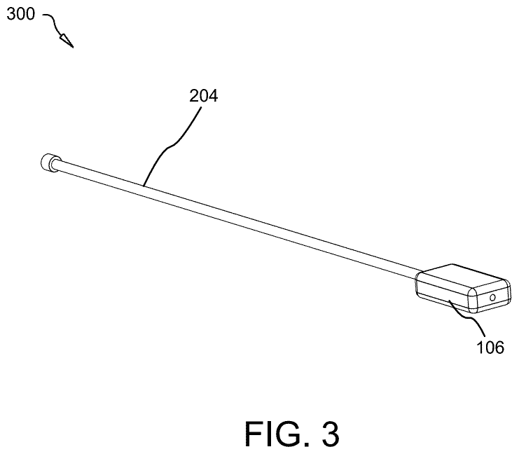

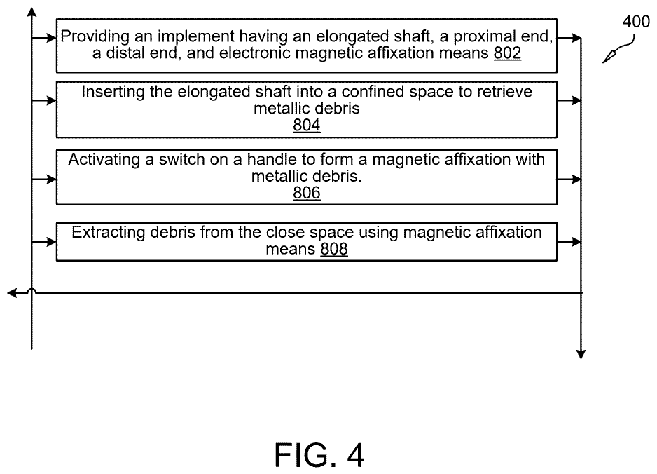

FIGS. 1 and 4 are perspective view illustrating embodiments of an extraction implement for retrieving foreign object debris 100, 300 in accordance with the present invention.

The extraction and insertion implement 100, hereafter “implement 100”, comprises a rod 102 that is configured to be manipulated by holding a handle 106 comprising a power supply such as a battery and switch. The rod 102 includes a proximal end 108 and a distal end 110. The proximal end 108 may be held between the fingers for manipulation of the rod 102.

The housing 106 may comprise a polymeric case defining a hollow interior recess.

In one non-limiting embodiment, the rod 102 is generally rigid and elongated. The rigid configuration allows the rod 102 to be manipulated in and around small spaces, crevices, holes, and irregular cavities without bending or breaking. This rigidity provides greater control and stability of the rod 102 when being manipulated axially and laterally in small spaces. The rod 102 may also have a generally cylindrical shape. Alternatively, the rod 102 may be square, ovoid or irregularly-shaped to creates a smoother rotational motion for rotating the rod 102 in small spaces.

The rod 102 may be between eight inches and 80 inches in length and may define a hollow interior recess through which connective wires traverse. The rod 102 may be formed from a semi-rigid polymeric material, such as nylon, fiberglass, or TAC.

However in other embodiments, the rod 102 may be semi-rigid and adaptable to bend around corners.

The implement 100 may further comprises a flaring tip 104 (i.e. flange) at a proximal end 108 of the rod 102. The flaring tip may be an electromagnet.

The rod 102 may comprise a flexible twist tie, or polymeric shaft have semi-flexible conductors which hold a form applied to them. The conductors may serve both to conduct electricity to the magnet 104, the camera 122 and/or the light 124 as well as to give the rod 102 rigid, or semi-rigid, form. The magnet may be circular and larger in diameter than the rod 102.

The rod 102 may be ¼ inch in diameter. In various embodiments, a flexible polymeric sleeve envelopes the rod 102. In alternative embodiments, the rod 102 is between ⅛ inch and ½ inch in diameter.

The flaring tip 104 may comprise a larger surface area for engaging debris. In various embodiments, the flaring tip 104 is permanently affixed to the rod 102 and operable to prevent the camera 122 and/or the light 104 from sliding off the distal end of the rod 102.

In some embodiments, a second flange 104 disposes more proximally to the handle/housing 106 than the camera 122 and/or light 124 to prevent sliding of the camera 122 and/or the light 124 in a proximal direction.

In various embodiments, the implement 100 comprises a camera 122 and/or an LED light 124. The camera 122 may be wireless or wired. The electrical connectors powering the camera 122 and/or the light 124 may housed interiorly within the rod 102. Switches, operable to power on the magnet 104, the camera 122 and/or the LED light 124 are disposed about, on or within the housing 106.

The camera 122 and the light 124 are affixed to the exterior of the rod 102 within two inches of the terminal, distal end 108. In various embodiments, the light 124 is positioned behind the camera 122 such that the light does not obstruct the view of the camera 122.

In various embodiments, the camera 122 and the light 124, are each housed within separate cylindrical housings which are affixed to the rod 102. In some embodiments, the camera 122 and/or light 124 are affixed with a hose clamp or pipe clamp to the rod 104. One benefit of housing the light 124 in a separate housing from the camera 122 is that in this fashion the light 124 does not obscure the camera 122. The camera 124 and light 122 may also be spaced apart from one another axially about the rod 102 to further separate the light 124 from the camera 122. Alternatively, the housings 126a-b of the camera 122 and the light 124 may be adjacent to one another to conserve space when inserting the rod 102 into a closed space.

In some embodiments, both the camera and the light incorporate a separate power supply housed within the housing 126 and a switch to switch the camera and/or light on. In other embodiments, conductive wires protrude from the housing 126 and insert into the rod 102. In these embodiments, the light 124 and/or camera 122 may be separately switched on from the housing 106.

FIG. 2 is an environmental, perspective view illustrating one embodiment of an extraction implement 200 for retrieving foreign object debris in accordance with the present invention.

The implement 100 may be used to retrieve debris from a dashboard of vehicle 202 as shown.

FIG. 4 is a perspective view illustrating one embodiment of a method 400 for extracting debris in accordance with the present invention.

The method 400 in the disclosed embodiments substantially includes the steps necessary to carry out the functions presented above with respect to the operation of the described implement 100. In one embodiment, the method 400 includes an initial Step 402 of providing an implement 100 having an elongated shaft having a proximal end 108 and a distal end 110.

In some embodiments, the method 400 may include a step of orienting the distal end 108 of the rod 102 towards a small space. The distal end 108 of the rod 102 has attached thereto a flaring tip or flange 104.

In a further embodiment, the method 400 includes a Step 404 of inserting the apparatus 100 into the small space. In a further embodiment, the method 400 includes a Step of engaging a foreign object debris with the flange, whereby the large surface area of the flange amplifies engagement with the foreign object debris.

In a further embodiment, the method 400 includes a Step 808 of extracting the foreign object debris from the small space (i.e., close space), whereby the flange 104 binds with the foreign object debris using magnetic attachment means.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An implement to extract foreign object debris, the implement comprising:
a handle comprising a power supply;
a rod having a proximal end and a distal end, the rod further being generally rigid and elongated, the rod defining a hollow interior recess;
a first cylindrical housing affixed to an exterior surface of the rod, the first cylindrical housing comprising a camera;
a flange joined with the distal end of the rod, the flange member being substantially resilient, the flange comprising a conductive coil or forming a magnetic field.

2. The implement of claim 1, wherein the first cylindrical housing comprises an integrated power supply and switch operable to switch on the camera.

3. The implement of claim 1, wherein the rod has a generally cylindrical shape.

4. An implement to extract foreign object debris, the implement comprising:
a handle comprising a power supply;
a rod having a proximal end and a distal end, the rod comprising a polymeric shaft having interior semi-rigid conductors operable to conduct electricity to one or more of the magnet, a camera and a light, wherein the semi-rigid conductors are also operable to impart form applied to the rod; and
a flange joined with the distal end of the rod, the flange member being substantially resilient, the flange comprising a conductive coil or forming a magnetic field.

5. The implement of claim 4, wherein the rod has a generally cylindrical shape.

6. The implement of claim 4, further comprising an LED light.

7. The implement of claim 4, further comprising a camera.
